(19) United States
(12) Patent Application Publication
(10) Pub. No.: US 2013/0207717 A1
(43) Pub. Date: Aug. 15, 2013

(54) Charge Pump Circuit

(71) Applicant: Daisuke Matsuoka, Tokyo (JP)

(72) Inventor: Daisuke Matsuoka, Tokyo (JP)

(73) Assignee: Asahi Kasei Microdevices Corporation, Tokyo (JP)

(21) Appl. No.: 13/765,829

(22) Filed: Feb. 13, 2013

(30) Foreign Application Priority Data
Feb. 14, 2012 (JP) 2012-029589
Dec. 14, 2012 (JP) 2012-273615

(51) Int. Cl. G05F 1/10

(52) U.S. Cl. CPC G05F 1/10
USPC 327/536

(57) ABSTRACT

A charge pump circuit according to the present invention includes a plurality of charge pump units each including a capacitor and connected to each other in parallel; a current source connected to commonly connected power source terminals of the plurality of charge pump units; and a control circuit connected to commonly connected output terminals and controlling an amount of a current to be supplied by the current source to the commonly connected power source terminals based on an output signal at the output terminals output signal from the plurality of charge pump units. Always in at least one charge pump unit, a current from the current source via the power source terminal is supplied to the capacitor. A spike noise due to a change in current is not generated and characteristics degradation of the other circuit can be prevented.

### CROSS-REFERENCE TO RELATED APPLICATIONS

This application claims the benefit of Japanese Patent Application Nos. 2012-029589, filed Feb. 14, 2012 and 2012-273615, filed Dec. 14, 2012, which are hereby incorporated by reference herein in their entirety.

### BACKGROUND OF THE INVENTION

1. Field of the Invention

The present invention relates to a charge pump circuit and more specifically, to a charge pump circuit that does not generate noise due to a change in current and can prevent characteristics degradation.

2. Description of the Related Art

Conventionally, a charge pump circuit has been directly connected to an input power source. Since a current flowing between the input power source and ground is changed by an operation of the charge pump circuit, along with the operation thereof, the noise is generated in the input power source and the ground. Thus, a current variation along with the operation of the charge pump circuit causes characteristics degradation of other circuits that are connected to the input power source or the ground, which is the same as that of the charge pump circuit.

Therefore, in a conventional charge pump circuit 102 illustrated in FIG. 1, a plurality of charge pump units 1, 2, . . . , n is connected to each other in parallel between an input power source 10 and the ground, a current I flowing therebetween is divided by the operation of each charge pump unit and, further, timing of temporal change of respective divided currents I1 to In is shifted from one another to suppress variations of an input power source potential and a ground potential and suppress the generation of the noise (refer to, e.g., Japanese Patent Application Laid-Open No. H11-025673(1999)).

However, since the input power source is directly connected to an input voltage terminal of each charge pump unit, as illustrated in FIG. 2, along with the operation of each of the charge pump units 1, 2, . . . , n, the currents I1 to In abruptly or momentarily change in a spike-like manner, and thus the current I flowing from the input power source to the ground is fluctuated to generate the noise in the input power source or the ground. Due to the noise, the characteristics of other circuits (not illustrated) connected to the input power source or the ground, which is the same as that of the charge pump circuit 102, are degraded.

### SUMMARY OF THE INVENTION

The present invention is directed to prevent generation of noise of a power source input or ground by preventing a spike-like change in current flowing from the power source input to the ground in a charge pump circuit.

A charge pump circuit according to the present invention devised by the applicant after analyzing causes of conventional problems in order to solve the problems comprises a plurality of charge pump units each including a capacitor and connected to each other in parallel; a current source connected to commonly connected power source terminals of the plurality of charge pump units; and a control circuit connected to commonly connected output terminals of the plurality of charge pump units, wherein the control circuit controls an amount of a current to be supplied by the current source to the commonly connected power source terminals based on an output signal at the output terminals from the plurality of charge pump units.

Preferably, the plurality of charge pump units each includes a plurality of switch elements connected to the capacitor; and the plurality of charge pump units operates to alternately repeat, by a cooperation of the plurality of switch elements to open or close, a charge period in which a current from the current source via the commonly connected power source terminals is divided and supplied to the capacitors and a transfer period in which charge accumulated in the capacitors in the charge period is transferred to a load via the commonly connected output terminals, wherein at least one of the plurality of charge pump units always operates in the charge period.

Preferably, the control circuit can control a current amount of the current source based on an output voltage of the plurality of charge pump units at the commonly connected output terminals, and more preferably the control circuit can control a current amount of the current source so that the output voltage becomes a constant voltage according to a predetermined reference voltage.

Preferably, the control circuit can control a current amount of the current source based on a load current flowing from the output terminals, more preferably, the control circuit can convert the load current into a voltage and control the current amount of the current source so that the converted voltage becomes the constant voltage according to a predetermined reference voltage, alternatively, can control a current amount of the current source so that the load current becomes a constant current according to a predetermined reference current.

Preferably, the commonly connected power source terminals are positive power source terminals and the current source is connected between the positive power source terminals and a positive power source, alternatively, the commonly connected power source terminals are negative power source terminals and the current source is connected between the negative power source terminals and a negative power source, alternatively, the commonly connected power source terminals are ground terminals and the current source is connected between the ground terminals and a ground power source.

Preferably, a current amount of the current source changes depending on a variation of an output voltage at the commonly connected output terminals according to control by the control circuit, and the change can include no spike-like change, alternatively, changes depending on a variation of a load current from the commonly connected output terminals according to control by the control circuit and the change can include no spike-like change.

The charge pump circuit according to the present invention is more preferably implemented in a semiconductor integrated circuit device.

According to the present invention, each of a plurality of charge pump units including the current source between the input power source and the input terminals of the charge pump circuit and connected to each other in parallel operates so that at least one or more charge pump units are always in a period in a temporal change in which period the current is caused to flow from the current source, and thus the spike-like change of the current flowing in the current source can be prevented and the generation of the noise due to the change in current can be prevented. Therefore, characteristics degradation of other circuits connected to the input power source or the ground, which is the same as that of the charge pump circuit, can be prevented.

Further features of the present invention will become apparent from the following description of exemplary embodiments (with reference to the attached drawings).

### BRIEF DESCRIPTION OF THE DRAWINGS

FIG. 1 is a circuit diagram illustrating a conventional charge pump circuit;

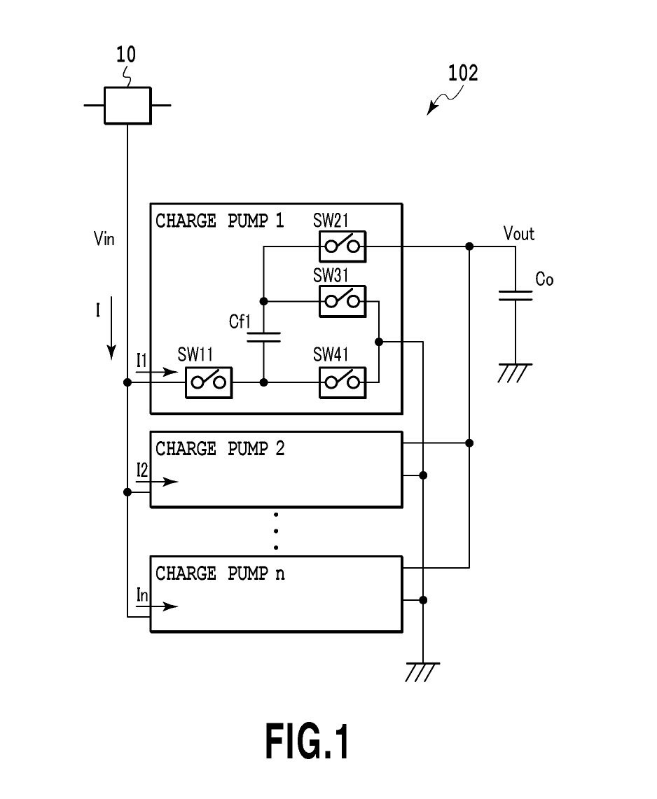

FIG. 2 is a characteristic diagram illustrating an example of a temporal change in current flowing between an input power source and ground along with an operation of a charge pump;

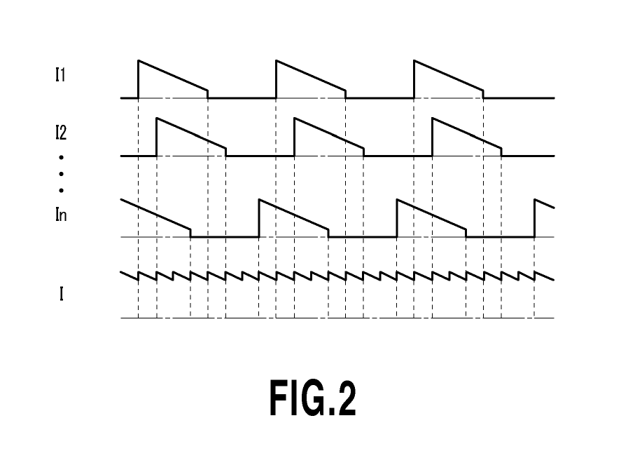

FIG. 3 is a circuit diagram illustrating a first embodiment of the charge pump circuit according to the present invention;

FIG. 4 is an operation explanatory diagram when two charge pump units are provided in the first embodiment;

FIG. 5 is an operation explanatory diagram when three or more charge pump units are provided in the first embodiment;

FIG. 6 is an operation explanatory diagram when three or more charge pump units are provided in the first embodiment;

FIG. 7 is a circuit diagram illustrating a more specific configuration of the first embodiment;

FIG. 8 is a circuit diagram illustrating a second embodiment of the charge pump circuit according to the present invention;

FIG. 9 is a circuit diagram illustrating a third embodiment of the charge pump circuit according to the present invention;

FIG. 10 is a circuit diagram illustrating a more specific configuration of the third embodiment; and

FIG. 11 is a circuit diagram illustrating a fourth embodiment of the charge pump circuit according to the present invention.

### DESCRIPTION OF THE EMBODIMENTS

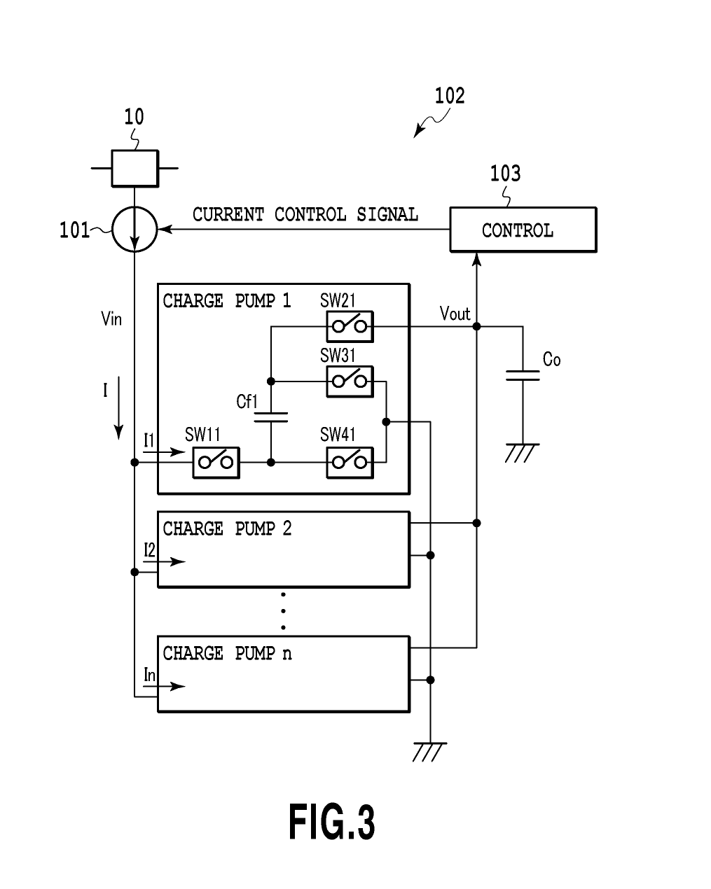

With reference to FIG. 3, a first embodiment of the present invention will be described below.

FIG. 3 illustrates the first embodiment of a charge pump circuit according to the present invention.

A charge pump circuit 102 includes a current source 101, a plurality of charge pump units 1 to n (n is an integer greater than 2), and a control circuit 103.

The charge pump circuit 102 includes at least two charge pump units 1 to n connected to each other in parallel, and the current source 101 inserted between positive voltage input terminals of the charge pump units 1 to n and a positive input power source 10. The charge pump circuit 102 further includes a control circuit 103 controlling a current amount of the current source 101 based on a voltage of the output terminals of the charge pump units 1 to n.

Each of the charge pump units 1 to n is a negative voltage generating charge pump including four switches SW 11, SW 21, SW 31, and SW 41, and a flying capacitor Cf1. A smoothing capacitor Co smooths the output voltage of the charge pump.

Further, voltage input terminals and voltage output terminals of the at least two or more charge pump units 1 to n connected to each other in parallel are commonly connected, respectively, and the current source 101 is inserted between the voltage input terminals and the input power source 10. The control circuit 103 inputs a voltage Vout of the output terminals of the charge pump units 1 to n to generate a current control signal for controlling the current amount of the current source 101. The control circuit 103 then controls the current amount of the current source 101 based on the voltage Vout of the output terminals of the charge pump units 1 to n. With the configurations described above, an abrupt and momentary change in the spike-like shape of the current flowing between the input power source and the ground can be prevented, and thus the characteristics degradation of other circuits connected to the input power source or the ground, which is the same as that of the charge pump circuit 102, can be prevented.

As described above, by using the charge pump circuit according to the present invention, a value of the current flowing from the input power source to the ground can be maintained as the current value according to an output voltage variation or a load current variation without abruptly or momentarily changing in the spike-like manner along with a charge pump operation.

By using the circuit configured as described above, the current flowing to the input terminal of the charge pump unit can be adjusted depending on the output voltage.

At this time, the charge pump units 1 to n operate so that at least one of the charge pump units 1 to n is in a phase (charge period) in which the current flows from the current source 101. Here, to acquire a stable current value from the current source 101, an amount of change of the input voltage Vin of the charge pump circuit 102 relative to time may be suppressed and a voltage value maybe set sufficiently lower than that of the input power source 10. Therefore, when the amount of the change of Vin relative to time is defined as Vd, a total value of capacity values of the flying capacitors Cf1 of the n charge pump units is defined as Cf, a time of one period for a circuit operation of the charge pump unit is defined as “T”, Vd that is the amount of the change of Vin relative to time can be expressed by Vd=I×T÷Cf using the amount of the current “I” of the current source 101, Cf, and T. Thus, the stable current value can be acquired from the current source 101, in some cases, by setting the time “T” of the one period shorter, or setting Cf greater.

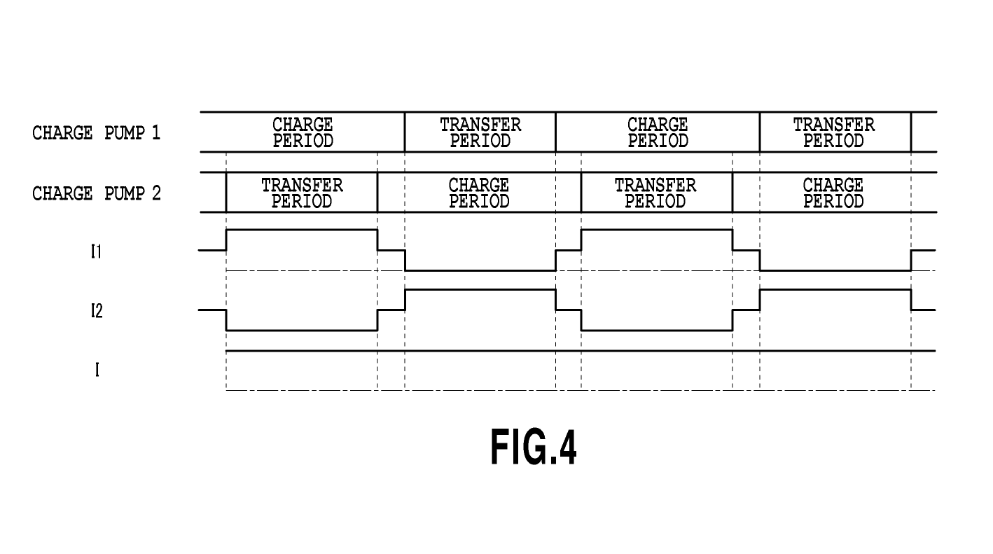

FIG. 4 is an operation explanatory diagram for illustrating an operation principle according to the first embodiment.

FIG. 4 illustrates, when the charge pump circuit 102 includes two charge pump units 1, 2 connected to each other in parallel (when n=2 in FIG. 3) , the periods of the temporal change for each of the charge pump units 1, 2, waveforms of the current I1, I2 flowing to the respective charge pump units 1, 2, and waveforms of the current “I” flowing from the input power source to the ground.

A charge period illustrated in FIG. 4 refers to a period when the current is charged into the flying capacitor Cfl in the charge pump unit, or a period when SW 11 and SW 31 are turned on and SW 21 and SW 41 are turned off that are the switches in the charge pump unit as illustrated in FIG. 3, and thus the current flows from the input power source to the ground via a path passing the current source 101 connected to the input power source, SW 11, the flying capacitor Cf1, and SW 31.

A transfer period illustrated in FIG. 4 refers to a period when a charge accumulated in the flying capacitor Cf1 in the charge period is transferred to a load via the output terminal, or a period when SW 21 and SW 41 are turned on and SW 11 and SW 31 are turned off that are the switches in the charge pump unit, and thus the current does not flow to the charge pump unit from the current source 101, and the current does not flow from the input power source to the ground.

As illustrated in FIG. 4, the currents I1 and 12 respectively flowing in the charge pump units 1, 2 change along with time. Through the whole time, at least one of the two charge pump units is always in the charge period, and the current always flows via the above-described path from the current source 101. Therefore, the current I from the current source 101 having a value substantially equal to a total of the currents flowing in the two charge pump units 1, 2 never stops.

The control circuit 103 is supplied with the output voltage Vout to generate the current control signal so that the current value of the current source 101 is controlled to the current value according to the load current of the charge pump circuit.

With this arrangement, the current flowing from the input power source to the ground does not abruptly or momentarily change in the spike-like manner along with the charge pump operation, and thus the generation of the noise in the input power source or the ground can be suppressed. Therefore, the characteristics degradation of other circuits connected to the same input power source or the ground is not induced.

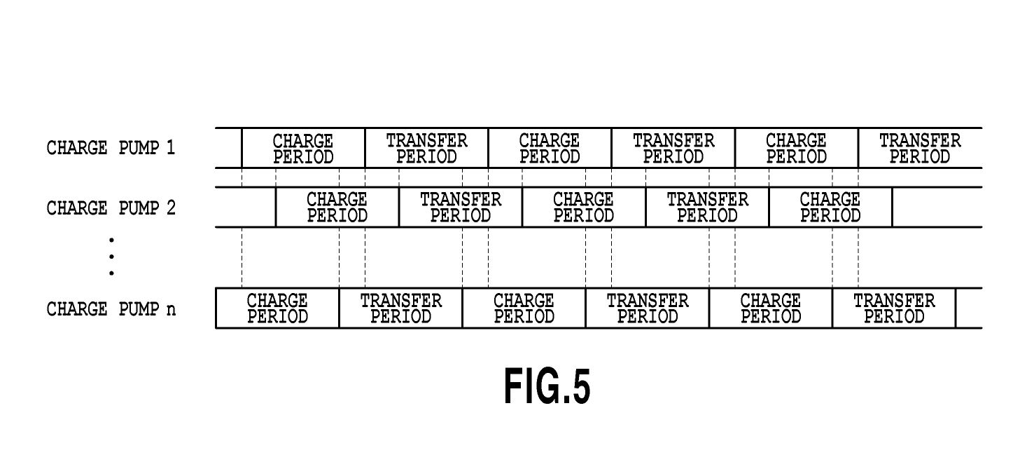

FIG. 5 is an operation explanatory diagram, when the charge pump circuit 102 that is a typical embodiment of the first embodiment includes then (n is an integer greater than 2) charge pump units connected to each other in parallel, that indicates periods of the temporal change of the each charge pump unit.

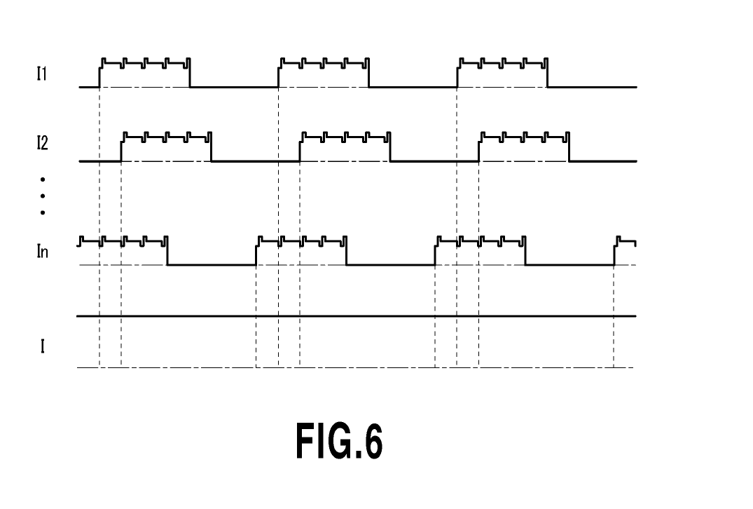

FIG. 6 illustrates the temporal change of the currents I1, I2, . . . , In respectively flowing through the charge pump units 1, 2, . . . , n and the current “I” flowing from the input power source to the ground when the charge pump circuit of the present embodiment is operated in the charge period and the transfer period of the temporal change illustrated in FIG. 5, and further when the load current is constant.

With reference to FIG. 6, it can be understood that the currents I1, I2, . . . , In respectively flowing through the charge pump units 1, 2, . . . , n vary in inverse proportion to the number of charge pump units being in the charge period, but the value of the current flowing in the current source 101 is constant that is substantially equal to the total of the currents flowing through the plurality of charge pump units being in the charge period. With this arrangement, the current flowing from the input power source to the ground does not abruptly or momentarily change in the spike-like manner, and thus the noise to be generated in the input power source or the ground can be suppressed.

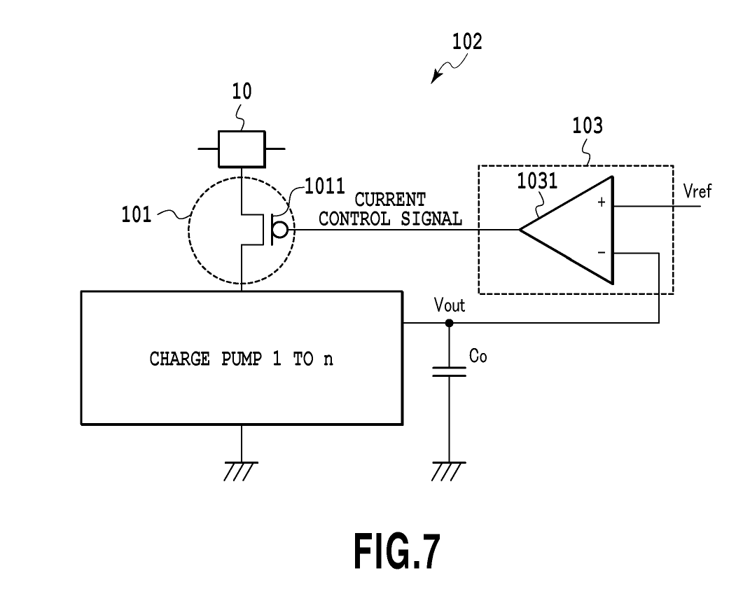

FIG. 7 is a circuit diagram illustrating a configuration of the first embodiment more specifically.

The current source 101 includes a MOS transistor, for example, a P-type MOS transistor 1011. The control circuit 103 includes an operational amplifier 1031, compares Vref that is a reference voltage with Vout that is an output voltage of the charge pump circuit, and controls a gate voltage of the MOS transistor 1011 with the current control signal that is an operational amplifier output so that the output voltage Vout becomes a constant voltage according to the reference voltage Vref .

### Second Embodiment

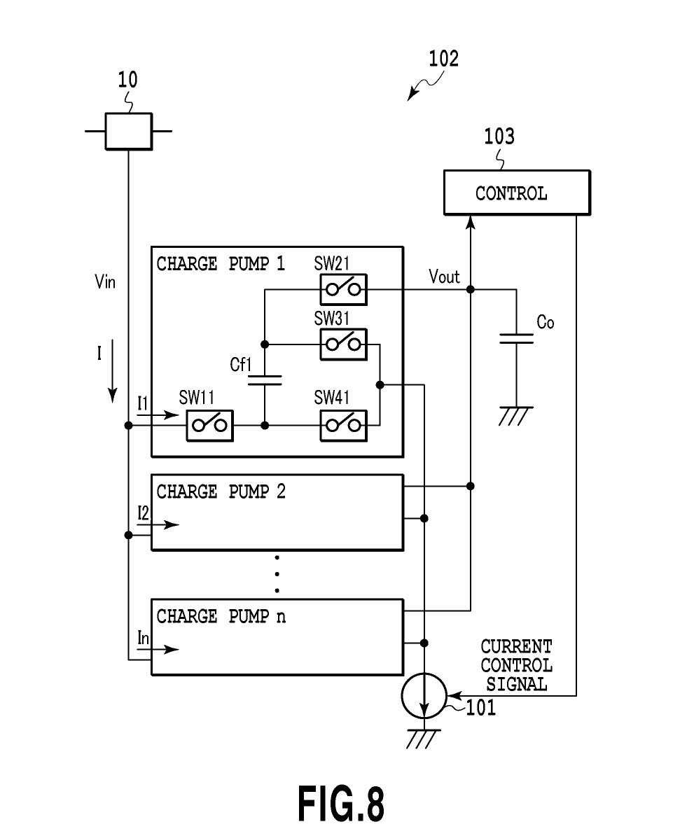

The charge pump circuit 102 according to the first embodiment illustrated in FIG. 3 is an example where the current source 101 is inserted between the positive voltage input terminals of the charge pump units 1 to n and the positive input power source. However, as with a second embodiment illustrated in FIG. 8, the second embodiment where the current source 101 is inserted between ground input terminals that are negative voltage input terminals of the charge pump units 1 to n and the ground that is a negative input power source can provide a similar operation effect to that of the first embodiment.

### Third Embodiment

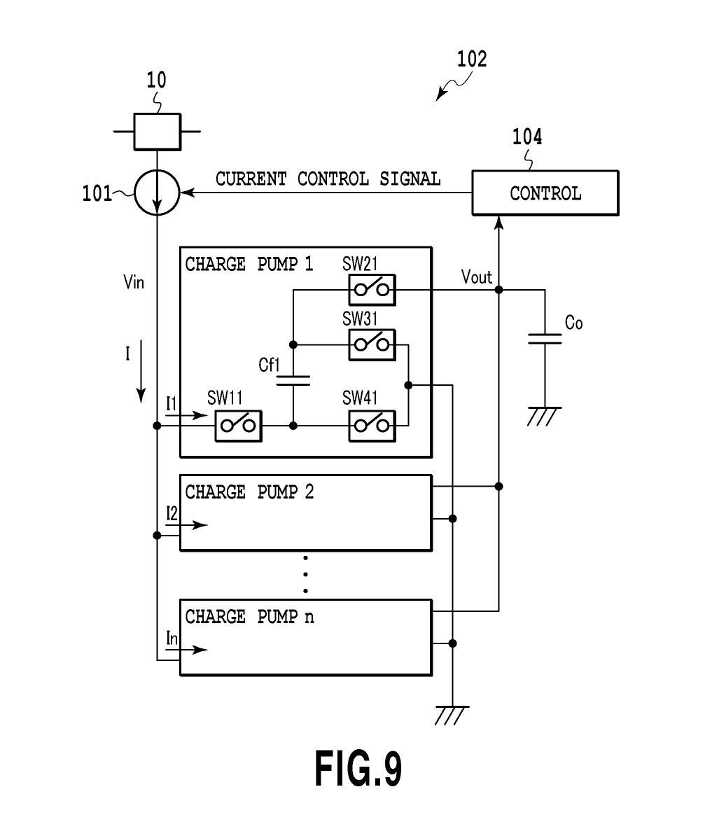

With reference to FIG. 9, another embodiment of the present invention will be descried below.

FIG. 9 is a circuit diagram of a third embodiment of the charge pump circuit according to the present invention.

The charge pump circuit 102 has a configuration using a control circuit that senses the load current, and includes the charge pump units 1 to n, the current source 101 connected between the positive input voltage terminals of the charge pump units 1 to n and the positive input power source, and the control circuit 104.

In the charge pump circuit illustrated in FIG. 9, the current control signal that is the output signal of the control circuit 104 performs the substantially same work as that of the current control signal that is the output signal of the control circuit 103 according to the above-described embodiment, and controls the current flowing in the current source 101 to the constant value according to the load current of the charge pump circuit 102. With this arrangement, the current flowing from the input power source to the ground does not abruptly or momentarily change in the spike-like manner, and thus the noise to be generated in the input power source or the ground can be reduced. Therefore, the characteristics degradation of other circuits connected to the input power source or the ground, which is the same as that of the charge pump circuit, is not induced.

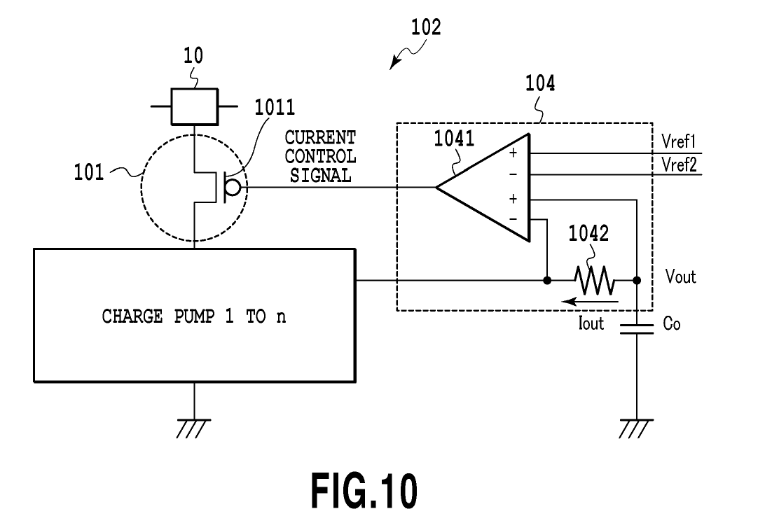

FIG. 10 is a circuit diagram illustrating a configuration of the charge pump circuit in more detail than that of the third embodiment.

The current source 101 includes the MOS transistor and, for example, the P-type MOS transistor 1011. The control circuit 104 includes an operational amplifier 1041. A resistance 1042 is connected to the control circuit 104 to monitor an output current lout of the charge pump units, Vref1 and Vref2 that are the reference voltages are compared with the voltages corresponding to the output currents of the charge pump units 1 to n, and the gate voltage of the P-type transistor 1011 is controlled with the current control signal that is an output so that a voltage difference at both sides of the resistance 1042 becomes the constant value according to a difference between the reference voltages Vref1 and Vref2.

Note that, the operational amplifier 1041 is a voltage comparator for comparing the reference voltages Vref1 and Vref2 with the voltage corresponding to the output current of the charge pump. However, in place of the arrangement described above, the resistance 1042 may be removed, and the operational amplifier 1041 may be a current comparator for directly comparing the reference current with the output current of the charge pump units 1 to n.

As described above, in the charge pump circuit according to the present invention, the value of the current flowing from the input power source to the ground can be maintained as the constant value depending on the current flowing out from the output of the charge pump circuit, in other words, the current value according to the output voltage variation or a load current variation without abruptly or momentarily changing in the spike-like manner along with a charge pump operation. Therefore, the generation of the noise of the input power source or the ground can be prevented so that the characteristics degradation of the other circuits connected to the input power source or the ground, which is the same as that of the charge pump circuit, can be prevented.

### Fourth Embodiment

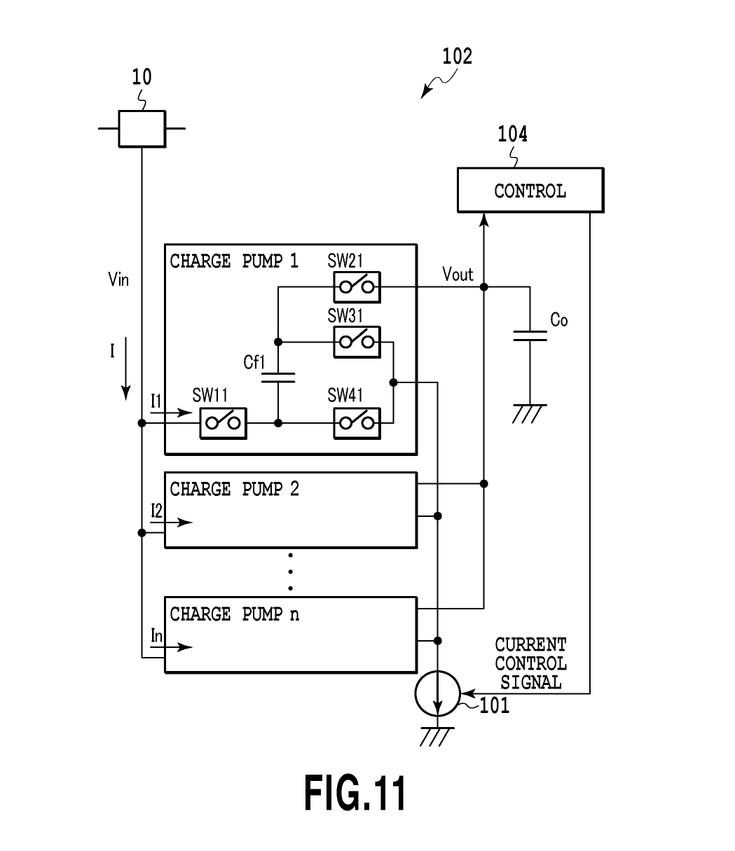

The charge pump circuit according to the third embodiment illustrated in FIG. 9 is an example where, when the control circuit 104 is used, the current source 101 is inserted between the positive voltage input terminals of the charge pump units and the positive input power source. However, as with a fourth embodiment illustrated in FIG. 11, the fourth embodiment having a configuration in which the current source 101 is inserted between the ground input terminals that are the negative voltage input terminals of the charge pump units and the ground that is a negative input power source can provide the similar operation effect to that of the third embodiment.

Note that, according to the above-described embodiment, the charge pump units 1 to n refer to negative voltage generating charge pumps for stepping-down the voltage to be input, but, in place of the negative voltage generating charge pumps, positive voltage generating charge pumps for stepping-up the voltage to be input can be also used.

Further, as indicated by each illustrated embodiment, the current source 101 may be inserted between the positive voltage input terminals of the charge pump units and the positive input power source (FIGS. 3, 7, 9, 10) or between the ground input terminals of the charge pump units and the ground (FIGS. 8, 11). Furthermore, though not illustrated, the current source may be inserted between the negative voltage input terminals of the charge pump units and the negative input power source.

Moreover, one current source maybe inserted between the positive voltage input terminals of the charge pump units and the positive input power source, and another one may be inserted between the ground input terminals of the charge pump units and the ground (or, between the negative voltage input terminals and the negative input power source), and the two current sources may be simultaneously controlled by the control circuit.

Note that, the charge pump circuit of each embodiment described above is particularly preferable when being implemented in the semiconductor integrated circuit device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A charge pump circuit comprising:
a plurality of charge pump units each including a capacitor and connected to each other in parallel;
a current source connected to commonly connected power source terminals of the plurality of charge pump units; and
a control circuit connected to commonly connected output terminals of the plurality of charge pump units, wherein the control circuit controls an amount of a current to be supplied by the current source to the commonly connected power source terminals based on an output signal at the output terminals from the plurality of charge pump units.

2. The charge pump circuit according to claim 1, wherein:
the plurality of charge pump units each includes a plurality of switch elements connected to the capacitor; and
the plurality of charge pump units operates to alternately repeat, by a cooperation of the plurality of switch elements to open or close, a charge period in which a current from the current source via the commonly connected power source terminals is divided and supplied to the capacitors and a transfer period in which charge accumulated in the capacitors in the charge period is transferred to a load via the commonly connected output terminals, wherein at least one of the plurality of charge pump units always operates in the charge period.

3. The charge pump circuit according to claim 1, wherein the control circuit controls a current amount of the current source based on an output voltage of the plurality of charge pump units at the commonly connected output terminals.

4. The charge pump circuit according to claim 3, wherein the control circuit controls a current amount of the current source so that the output voltage becomes a constant voltage according to a predetermined reference voltage.

5. The charge pump circuit according to claim 1, wherein the control circuit controls a current amount of the current source based on a load current flowing from the output terminals.

6. The charge pump circuit according to claim 5, wherein the control circuit converts the load current into a voltage and controls a current amount of the current source so that the converted voltage becomes a constant voltage according to a predetermined reference voltage.

7. The charge pump circuit according to claim 5, wherein the control circuit controls a current amount of the current source so that the load current becomes a constant current according to a predetermined reference current.

8. The charge pump circuit according to claim 1, wherein the commonly connected power source terminals are positive power source terminals, and the current source is connected between the positive power source terminals and a positive power source.

9. The charge pump circuit according to claim 1, wherein the commonly connected power source terminals are negative power source terminals and the current source is connected between the negative power source terminals and a negative power source.

10. The charge pump circuit according to claim 1, wherein the commonly connected power source terminals are ground terminals and the current source is connected between the ground terminals and a ground power source.

11. The charge pump circuit according to claim 1, wherein a current amount of the current source changes depending on a variation of an output voltage at the commonly connected output terminals according to control by the control circuit and the change does not include a spike-like change.

12. The charge pump circuit according to claim 1, wherein a current amount of the current source changes depending on a variation of a load current from the commonly connected output terminals according to control by the control circuit and the change does not include a spike-like change.
